(19) United States
(12) Patent Application Publication
(10) Pub. No.: US 2005/0217532 A1
(43) Pub. Date: Oct. 6, 2005

(54) Tight curve high rail vehicle

(76) Inventor: Martin C. Conneally, Downers Grove, IL (US)

Correspondence Address: BARNES & THORNBURG, P.O. BOX 2786, CHICAGO, IL, 60690-2786, US

(21) Appl. No.: 11/094,464

(22) Filed: Mar. 30, 2005

Related U.S. Application Data
(60) Provisional application No. 60/557,781, filed on Mar. 30, 2004.

(51) Int. Cl. B62D 25/20

(52) U.S. Cl. 105/215.1

(57) ABSTRACT

A high-rail assembly for use with a high-rail vehicle to prevent derailment upon the negotiation of a tight railway curve. The high-rail assembly is comprised of a friction hub, which is attached to a shaft supported by a pivotal bracket assembly. The high-rail assembly further comprises a rail wheel assembly that is supported by a second shaft. The friction hub is adapted to engage the drive wheels of the truck and in turn causes the rotation of the of the rail wheel assembly, which ultimately drives the high-rail truck. Movement of the friction hub and rail drive wheel is accomplished by use of a hydraulic cylinder, which pivots a bracket assembly. The present arrangement allows the wheelbase between the rail drive wheels to be minimized, permitting the high-rail truck to negotiate tight radius curves without derailing.

This application claims priority from U.S. Provisional Application Ser. No. 60/557,781 filed Mar. 30, 2004.

### BACKGROUND

This disclosure relates to high-rail vehicles adapted to travel along railway rails and more specifically to a high-rail assembly that allows vehicles to negotiate tight railway curves, reducing the likelihood of derailment of the high-rail vehicle.

High-rail vehicles are utilized by the rail industry to allow street driven vehicles such as pickup trucks to travel along the nations rails. This is advantageous since it allows vehicles with specialized repair equipment to travel along the rails to the location in need of repair. Often times areas of rail in need of repair are inaccessible by road. The service technicians are able to drive the high-rail truck to the rail/roadway intersection closest to the repair area and drive the truck along the rails. To engage the rails, the driver aligns the wheels of the high-rail truck parallel to the rails and engages the rail drive gear. The rail drive gear consists of a series of rail wheels that are adapted to engage the rail and elevate a portion or all of the high-rail truck. Typically the drive wheels of the high-rail truck engage the rails and propel the high-rail truck down the rails. Typical designs of high-rail trucks do not permit the high-rail truck to negotiate tight rail curves because the mechanism for retracting and extending the high rail wheels requires an overly long wheel base. Attempting to do so causes the high-rail truck with prior art wheels to derail, oftentimes requiring a tow vehicle to free the high-rail truck caught between the rails.

In view of the above, it should be appreciated that there is a need for a high-rail assembly that can allow a vehicle to negotiate tight railway curves without causing derailment of the high-rail truck. The present disclosure satisfies these and other needs and provides further related advantages.

### SUMMARY

The disclosure comprises a high-rail assembly for use with a high-rail vehicle to prevent high-rail vehicle derailment upon the negotiation of a tight railway curve.

The high-rail assembly is comprised of a friction hub, which is attached to a shaft supported by a pivotal bracket assembly. The high-rail assembly further comprises a rail wheel assembly that is supported by a second shaft. The friction hub is adapted to engage the drive wheels of the truck and in turn causes the rotation of the of the rail wheel assembly, which ultimately drives the high-rail truck. Movement of the friction hub and rail drive wheel is accomplished by use of a hydraulic cylinder, which pivots a bracket assembly. The present arrangement allows the wheelbase between the rail drive wheels to be minimized, permitting the high-rail truck to negotiate tight radius curves without derailing.

Other features and advantages of the disclosure will be set forth in part in the description which follows and the accompanying drawings, wherein the embodiments of the disclosure are described and shown, and in part will become apparent upon examination of the following detailed description taken in conjunction with the accompanying drawings.

### BRIEF DESCRIPTION OF THE DRAWINGS

The above mentioned and other features of this invention and the manner of obtaining them will become more apparent and the invention itself will be best understood by reference to the following description of embodiments of the invention taken in conjunction with the accompanying drawings in which:

FIG. 1 is a perspective view of the high-rail assembly connected to a vehicle;

FIG. 2 is a perspective view of the high-rail assembly illustrating the friction hub partially disassembled;

FIG. 3 is an exploded view of the high-rail assembly associated with a vehicle;

FIG. 4 is an exploded view of the high-rail assembly.

### DETAILED DESCRIPTION

While the present invention will be described fully hereinafter with reference to the accompanying drawings, in which a particular embodiment is shown, it is to be understood at the outset that persons skilled in the art may modify the invention herein described while still achieving the desired result of this invention. Accordingly, the description that follows is to be understood as a broad informative disclosure directed to persons skilled in the appropriate art and not as limitations on the present invention.

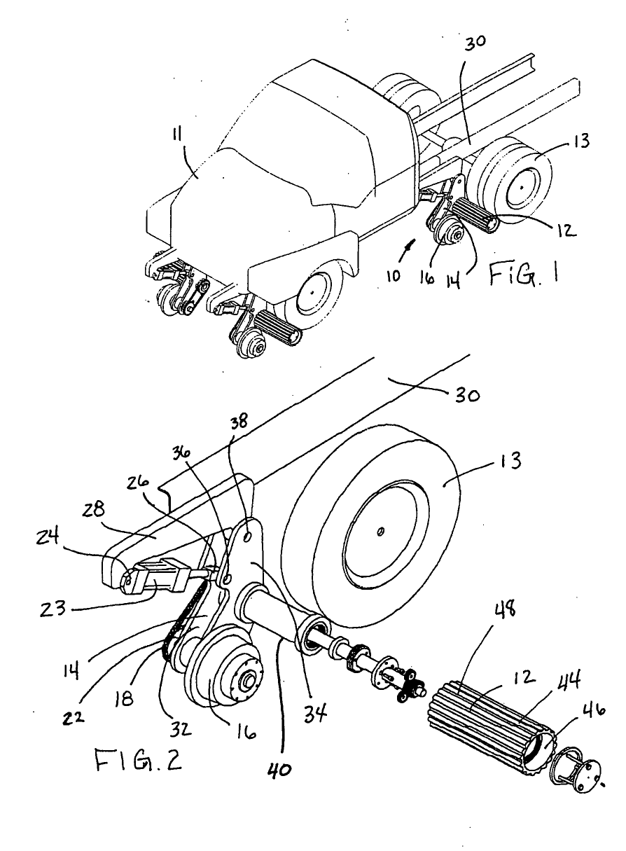

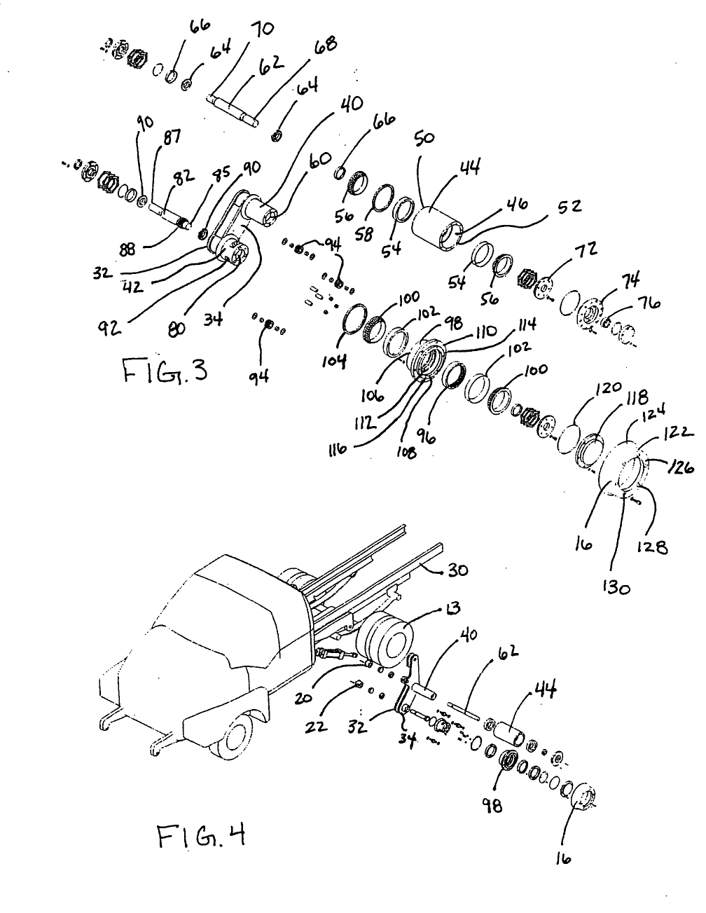

As illustrated in the drawings, a high-rail assembly 10 connected to a vehicle 11 includes a friction hub 12 that is pivotally connected to a bracket assembly 14. The friction hub 12 is adapted to engage a wheel 13 of the vehicle 11, as shown in FIGS. 1 and 2. The high-rail assembly 10 further includes a rail wheel 16 that is rotatably connected to the bracket assembly 14 and driven by the friction hub 12 by use of a chain 18 and first and second sprockets 20 and 22. The primary factor limiting the track radius that a high-rail vehicle can negotiate is the distance between the rail wheels. The present arrangement allows for a short wheelbase between rail wheels 16 for a given vehicle allowing the vehicle 11 to negotiate a tight radius.

The bracket assembly 14 includes a hydraulic arm 23 that comprises a first end 24 pivotally connected to a frame bracket 28, which is fastened to a frame member 30 of the vehicle 11. The hydraulic arm 23 further includes a spaced apart second end 26 that is pivotally connected to the bracket assembly 14. The bracket assembly 14 is pivotally connected to the frame bracket 28 and pivots away from the frame bracket 28 towards the wheel 13 of the vehicle 11 when the hydraulic arm 23 is extended to a second engaged position. The bracket assembly 14 comprises an inboard plate 32 and a spaced apart outboard plate 34. Each plate 32, 34 includes a first set of apertures 36 for pivotal attachment to the second end 26 of the hydraulic arm 23. Each plate 32, 34 further includes a second set of apertures 38 for pivotal attachment to the frame bracket 28. The bracket assembly 14 also includes a tubular stub shaft 40, extending outwardly from the outboard plate 34 and adapted to support the friction hub 12. The frame bracket further includes a second stub shaft 42.

The friction hub 12 is adapted to frictionally engage the drive wheel 13 of the vehicle 11, such that rotating the drive wheel 13 of the vehicle 11 causes the rotation of the friction hub 12. The friction hub 12 is a tubular member having an exterior cylindrical surface 44 and a spaced apart interior cylindrical surface 46. The friction hub 12 further includes a first side surface 50 and a spaced apart second side surface 52. One embodiment of the exterior cylindrical surface 44 includes a plurality of traction ribs 48 that enhance traction with the drive wheel 13 of the vehicle 11. While ribs 48 are shown, other textured surfaces may be used to enhance traction between the friction hub 12 and the drive wheel 13.

The interior cylindrical surface 46 of the friction hub 12 is adapted to accept a pair of bearing races 54, tapered roller bearings 56 and seal 58. The friction hub 12, along with the bearing races 54, bearings 56 and seal 58 are adapted to be positioned on the stub shaft 40, allowing the friction hub 12 to rotate with respect to the stub shaft 40. The stub shaft 40 includes a central opening 60 that is adapted to allow a shaft 62 to be positioned therein. The shaft 62 includes a first end 68 and a spaced apart second end 70. The first end 68 of the shaft 62 is threaded to accept a retaining nut 76. The shaft 62 is adapted to rotate within the stub shaft 40 and is supported by bearings 64 and races 66. The shaft 62 is interconnected to the friction hub 12 by use of first and second attachment plates 72, 74 and the retaining nut 76. The second end 70 of the shaft 62 extends outwardly from the inboard plate 32 of the bracket assembly 14 and is adapted to receive the first sprocket 20.

The second stub shaft 42 is spaced apart from the stub shaft 40 and extends outwardly from the outboard plate 34 of the bracket assembly 14. The second stub shaft 42 is adapted to pivotally support a rail wheel 16 and includes a first end 84 and a spaced apart second end 86. The rail wheel 16 is in direct contact with the railroad rails and propels the vehicle 11 when in use. The second stub shaft 42 includes a central bore 80 that is adapted to allow a drive shaft 82 to be positioned therein. The drive shaft 82 includes a first end 85 and a spaced apart second end 87. The first end 85 of the drive shaft 82 includes a drive gear 88. The drive gear 88 is one of several gears that make up a reversing gear set. The second end 87 of the drive shaft 82 extends outwardly from the inboard plate 32 of the bracket assembly 14 and is adapted to receive the second sprocket 22. The chain 18 is adapted to interconnect the first sprocket 20 to the second sprocket 22 to allow the rotational force of the friction hub 12 to be transferred to the rail wheel 16. The drive shaft 82 is supported within the second stub shaft 42 by use of bearings 90. The second stub shaft 42 includes a plurality of openings 92 adapted to accept planetary gears 94, which are adapted to engage the drive gear 88 within the second stub shaft 42. The planetary gears 94 are adapted to engage ring gear 96, which is positioned within a housing 98 of the rail wheel 16. The rotation of the drive shaft 82 in a first direction results in the rail wheel 16 turning in the opposite direction with the assistance of the reversing gear set. This arrangement allows the vehicle 11 to be driven in a forward direction on the rails while the normal over-the-road transmission is in a forward gear. The ring gear 96 is attached to the housing 98 either by pressure fit or by fasteners.

The housing 98 is adapted to be positioned over the second stub shaft 42 and is supported by a pair of tapered roller bearings 100 and bearing races 102. An inboard seal 104 is used to retain lubricant within the housing 98. The housing 98 includes a first side 106 and a spaced apart second side 108. The first side 106 of the housing 98 is positioned toward the outboard plate 34 of the bracket assembly 14. The second side 108 of the housing 98 includes a flange 110 having a plurality of apertures 114 and an outwardly extending ring 112, which also includes a plurality of apertures 116. The ring 112 is adapted to be connected to a retaining cap 118 to seal the housing 98. The retaining cap 118 includes an o-ring 120 that prevents contamination to the bearings and retains the lubricant within the housing 98.

The rail wheel 16 is adapted to travel along a standard railroad gauge track and includes a drum portion 122 and a flange 124. The drum portion 122 of the rail wheel 16 is adapted to ride along the top portion of the rail. The flange 124 of the rail wheel 16 is adapted to ride along the inside edge of the rail to retain the position of the Tail wheel 16 with respect to the rail. The rail wheel 16 on an outside surface 126 of the drum portion 122 includes a plurality of apertures 128 that are adapted to allow connection of the rail wheel 16 with the housing 98 with the use of fasteners 130.

In use, there is one high rail assembly 10 positioned in front of each of the wheels 13 of the vehicle 11. The vehicle is driven to a track/road intersection and the vehicle 11 is aligned with the rails. Once the vehicle 11 is in position, the hydraulic arms 23 are activated and the bracket assemblies 14 located at each wheel are pivoted downward causing the rail wheel 16 to engage the rails, elevating the wheels 13 of the vehicle 11 off the rails. The bracket assemblies 14 are pivoted rearward until the friction hub 12 fully engages the wheels 13 of the vehicle 11. At this stage, only the rail wheels 16 are in contact with the rails. To move the vehicle 11 down the tracks, the vehicle is placed in drive and the accelerator is pressed to rotate the drive wheels 13 of the vehicle 11. Rotation of the drive wheels 13 causes the counter rotation of the friction hub 12, which, in turn, causes the rotation of the first sprocket 20 and chain 18. Rotation of the chain causes the rotation of the second sprocket 22 and drive shaft 98. Rotation of the drive shaft 98 causes the counter rotation of the rail wheel 16 due to the reversing gear set. The resultant rotation of the rail wheel 16 is in the same direction as the drive wheels 13 of the vehicle 11. Diameters of the sprockets 20, 22 can be varied to calibrate rail speed to the speedometer of the vehicle 11. The present arrangement allows for the closest placement of the rail wheels 16, which allows the vehicle to negotiate tight rail curves.

Various features of the invention have been particularly shown and described in connection with the illustrated embodiment of the invention, however, it must be understood that these particular arrangements merely illustrate, and that the invention is to be given its fullest interpretation within the terms of the appended claims.

1. A high rail assembly for a vehicle comprising:
a bracket assembly pivotally connected to a vehicle;
a hydraulic assembly adapted to pivot said bracket assembly from a first position to a second position;
a friction hub rotatably connected to said bracket assembly, said friction hub adapted to engage a wheel of said vehicle when said bracket assembly is in a second position but disengage from said wheel when said bracket assembly is in a first position; and
a rail wheel rotatably connected to said bracket assembly, said rail wheel adapted to engage a rail and support said vehicle, said rail wheel also being adapted to engage said rail when said bracket assembly is in said second position but disengage from the rail when said bracket assembly is in said first position.

2. The high rail assembly of claim 1 wherein said bracket assembly comprises:
a frame connector fixedly attached to a frame member of the vehicle;
an inboard plate associated with said frame connector;
an outboard plate spaced apart from said inboard plate;
a first set of apertures in each of said inboard plate and said outboard plate for pivotally attaching said inboard and outboard plates to said frame connector;
a second set of apertures in each of said inboard plate and said outboard plate for pivotally attaching said inboard and outboard plates to said hydraulic assembly;
a tubular stub shaft extending outwardly from said outboard plate and adapted to support said friction hub; and
a second stub shaft, extending outwardly from said outboard plate and spaced apart from said first stub shaft, said second stub shaft being adapted to support said rail wheel.

3. The high rail assembly of claim 2 wherein said inboard plate and said outboard plate are arranged substantially parallel to each other.

4. The high rail assembly of claim 2 wherein said first set of apertures in said inboard and said outboard plates are substantially aligned.

5. The high rail assembly of claim 2 wherein said second set of apertures in said inboard and said outboard plates are substantially aligned.

6. The high rail assembly of claim 1 wherein said hydraulic assembly comprises:
an arm having a first end pivotally connected to said frame connector and a spaced apart second end, pivotally connected to said bracket assembly, wherein when said arm is engaged, said bracket assembly pivots away from said frame connector and towards said wheel of the vehicle.

7. The high rail assembly of claim 1 further comprising a tubular stub shaft extending outwardly from said outboard plate, said tubular stub shaft adapted to rotatably support said friction hub.

8. The high rail assembly of claim 7 wherein said friction hub comprises:
a tubular member having an exterior cylindrical surface, an interior cylindrical surface, a first side surface and a second side surface, said exterior cylindrical surface being in frictional contact with a wheel of a vehicle.

9. The high rail assembly of claim 8 further comprising:
at least one bearing race; and
at least one bearing, wherein said at least one bearing race and said at least one bearing are adapted to be positioned on said stub shaft and wherein said interior cylindrical surface of said friction hub is adapted to accept said at least one bearing race and said at least one bearing such that said friction hub is positioned about and is able to rotate relative to said stub shaft.

10. The high rail assembly of claim 9 further comprising:
a shaft having a first end and a spaced apart second end, said shaft being adapted to rotate within said tubular stub shaft, said first end of said shaft being connected to said friction hub, said shaft extending through said tubular stub shaft and extending outwardly from said inboard plate;
a first sprocket attached to said second end of said shaft;
a drive shaft having a first end and a spaced apart second end, said drive shaft being adapted to rotate within said second stub shaft, said first end of said drive shaft being connected to said rail wheel, said drive shaft extending through said second stub shaft and said second end of said drive shaft extending outwardly of said inboard plate;
a second sprocket attached to said second end of said drive shaft; and
a flexible interconnection member rotatably connecting said first sprocket and said second sprocket.

11. The high rail assembly of claim 10 wherein said flexible interconnection member is a chain.

12. The high rail assembly of claim 10 further comprising a reversing gear set having
a housing;
a drive gear fixedly connected to said first end of said drive shaft;
a plurality of planetary gears adapted to engage said drive gear; and
a ring gear positioned within said housing and adapted to engage said plurality of planetary gears, wherein the rotation of said drive shaft in a first direction results in rotation of the rail wheel in the opposite direction.

13. The high rail assembly of claim 8 wherein said exterior cylindrical surface is textured for enhancing frictional contact with a wheel of a vehicle.

14. The high rail assembly of claim 1 wherein said rail wheel comprises:
a drum portion adapted to engage a top portion of a rail; and
a flange adapted to engage an inside edge of said rail to retain the position of said wheel on said rail.

15. A high rail assembly for a vehicle comprising:
a bracket assembly pivotally connected to a vehicle, said bracket assembly having
a frame connector fixedly attached to a frame member of the vehicle,
an inboard plate associated with said frame connector,
an outboard plate spaced apart from said inboard plate,
a first set of apertures in each of said inboard plate and said outboard plate for pivotally attaching said inboard and outboard plates to said frame connector,
a second set of apertures in each of said inboard plate and said outboard plate for pivotally attaching said inboard and outboard plates to said hydraulic assembly,
a tubular stub shaft extending outwardly from said outboard plate, and
a second stub shaft, extending outwardly from said outboard plate and spaced apart from said first stub shaft;
a hydraulic assembly adapted to pivot said bracket assembly from a first position to a second position, wherein said hydraulic assembly comprises
an arm having a first end pivotally connected to said frame connector and a spaced apart second end, pivotally connected to said bracket assembly, wherein when said arm is engaged, said bracket assembly pivots away from said frame bracket and towards said wheel of the vehicle;
a friction hub rotatably connected to said bracket assembly in cooperation with said tubular stub shaft, said friction hub adapted to engage a wheel of said vehicle when said bracket assembly is in a second position but disengage from said wheel when said bracket assembly is in a first position, said friction hub comprising
a tubular member having an exterior cylindrical surface, an interior cylindrical surface, a first side surface and a second side surface, said exterior cylindrical surface being textured to enhance frictional contact with a wheel of the vehicle;
a rail wheel rotatably connected to said bracket assembly supported by said second stub shaft, said rail wheel adapted to engage a rail and partially support said vehicle, wherein said rail wheel is adapted to engage said rail when said bracket assembly is in said second position but disengage from the rail when said bracket assembly is in a first position;
a flexible interconnection member rotatably connecting said friction hub and said rail wheel; and
a reversing gear set wherein the rotation of said friction hub in a first direction results in rotation of the rail wheel in the opposite direction.

16. A vehicle adapted to travel along a railroad track comprising:
a frame;
a plurality of wheels rotatably connected to said frame; and
a plurality of high rail assemblies, each high rail assembly comprising:
a bracket assembly pivotally connected to a vehicle,
a hydraulic assembly adapted to pivot said bracket assembly from a first position to a second position,
a friction hub rotatably connected to said bracket assembly, said friction hub adapted to pivotally engage a wheel of said vehicle when said bracket assembly is in a second position but disengage from said wheel when said bracket assembly is in a first position,
a rail wheel rotatably connected to said bracket assembly, said rail wheel adapted to engage a rail and partially support said vehicle, wherein said rail wheel is adapted to engage said rail when said bracket assembly is in said second position but disengage from the rail when said bracket assembly is in a first position
a flexible interconnection member rotatably connecting said friction hub and said rail wheel,
a reversing gear set wherein the rotation of said friction hub in a first direction results in rotation of the rail wheel in the opposite direction.

17. The vehicle of claim 16 wherein one of said plurality of high rail assemblies is positioned proximate to each of said plurality of wheels.

18. The vehicle of claim 17 wherein one of said plurality of high rail assemblies is positioned in front of each of said plurality of wheels.

19. A system of high rail assemblies for a vehicle comprising:
a plurality of the high rail assemblies of claim 1 attached to a vehicle.

20. The system of claim 19 wherein one of said plurality of high rail assemblies is attached to a vehicle having a plurality of wheels proximate to each wheel.

21. The system of claim 20 wherein one of said plurality of high rail assemblies is attached to a vehicle in front of each wheel.
